(19) United States
(12) Patent Application Publication
(10) Pub. No.: US 2026/0230778 A1
(43) Pub. Date: Aug. 6, 2026

(54) Method and Apparatus for Charging

(71) Applicant: Telefonaktiebolaget LM Ericsson (publ), Stockholm (SE)

(72) Inventors: Zhansheng Wei, SHANGHAI (CN); Yunjie Lu, Shanghai (CN); Robert Törnkvist, Karlskrona (SE); Jiehong Yang, Mölndal (SE); Chunmiao Liu, Shanghai (CN)

(21) Appl. No.: 19/154,927

(22) PCT Filed: Feb. 7, 2024
(86) PCT No.: PCT/CN2024/076591

§ 371 Date: Aug. 8, 2025

(30) Foreign Application Priority Data
Feb. 13, 2023 (WO) PCT/CN2023/075701

(51) Int. Cl. H04W 4/24; H04W 8/02

(52) U.S. Cl. CPC H04W 4/24; H04W 8/02

(57) ABSTRACT

Embodiments of the present disclosure provide method and apparatus for charging. A method performed by a first session management function (SMF) comprises sending a protocol data unit (PDU) session create request to a second SMF. The method further comprises receiving a PDU session create response comprising a first charging identifier for the PDU session from a second SMF. The method further comprises sending to a first charging function a first charging data request comprising the first charging identifier and a network function instance identifier of the second SMF.

### PRIORITY CLAIM

This application claims the priority of a PCT application with International Application PCT/CN2023/075701 and International Filing Date Feb. 13, 2023.

### TECHNICAL FIELD

The non-limiting and exemplary embodiments of the present disclosure generally relate to the technical field of communications, and specifically to methods and apparatuses for charging.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks, there may be various sessions such as protocol data unit (PDU) sessions. For example, a user equipment (UE) may request PDU session establishment for home-routed roaming scenarios. A UE or a network may request PDU session modification for home-routed roaming scenarios. A UE may initiate PDU session handover from Evolved Packet System (EPS) to 5GS (fifth generation system).

According to clause 5.1.4 of 3GPP TS 32.255 V17.8.0, the disclosure of which is incorporated by reference herein in its entirety, a session management function (SMF) charging identifier (ID) is generated at the first SMF that processes the PDU session initiating request. The first SMF is the SMF in V-PLMN (Visited Public Land Mobile Network) for the home routed roaming PDU session. The charging ID (i.e., chargingId) assigned by the visited session management function (V-SMF) will be transferred to the home session management function (H-SMF) in the HPLMN (Home Public Land Mobile Network).

According to clause 5.1.9 of 3GPP TS 32.255 V17.8.0, for a PDU session handover from EPS to 5GS (in V-PLMN), the charging ID is transferred by the H-SMF to the V-SMF via ‘Home Provided Charging Id’ (i.e., homeProvidedChargingId). This ‘Home Provided Charging Id’ shall be used by the V-SMF to replace the existing Charging Id previously generated by V-SMF.

The chargingId/homeProvidedChargingId is encoded as a 32-bit unsigned integer value. Table 1 shows an example of chargingId/homeProvidedChargingId.

TABLE 1

| | | | | | |
|---|---|---|---|---|---|
| | Data | | | | |
| Attribute name | type | P | Cardinality | Description | Applicability |

| | | | | |
|---|---|---|---|---|
| chargingId/ | string | O | 0 . . . 1 | The string shall encode the Charging ID (32-bit unsigned |
| homeProvidedChargingId | | | | integer value, with maximum value “4294967295”) in |
| | | | | decimal representation. |
| | | | | Pattern: ‘\hat{ }(0\|([1-9]{1}[0-9]{0, 9}))$’ |
| | | | | NOTE: Usage of Charging ID with Uint32 value for |
| | | | | roaming scenarios may lead to Charging ID collision |
| | | | | between SMFs. |

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be some problems for the exiting charging solutions. For example, in home routed roaming scenario, the charging ID can be generated either in V-SMF (in case of PDU session establishment with V-SMF) or in H-SMF (in case of PDU session handover from EPS to 5GS with V-SMF). The SMFs on different physical nodes allocate charging IDs independently from each other which can result in that they may allocate identical charging IDs.

For example, the charging identifier may be generated by V-SMF1. When the charging identifier is transferred to the H-SMF, the same charging ID might already be used by the H-SMF and/or by another V-SMF (V-SMF2) connected to the same H-SMF for other PDU sessions.

If the charging identifier is generated by H-SMF and transferred to the V-SMF, the same charging ID might already be used by the V-SMF connected to other H-SMFs

As a result, it's possible to result a Charging ID collision between SMFs. Moreover when the same Charging ID for different PDU sessions is sent to a Charging Function (CHF), the Charging ID collision may occur in the CHF.

To overcome or mitigate at least one of above mentioned problems or other problems, the embodiments of the present disclosure propose an improved solution for charging.

In a first aspect of the disclosure, there is provided a method performed by a first session management function (SMF). The method comprises sending a protocol data unit (PDU) session create request to a second SMF. The method further comprises receiving a PDU session create response comprising a first charging identifier for the PDU session from a second SMF. The method further comprises sending to a first charging function a first charging data request comprising the first charging identifier and a network function instance identifier of the second SMF.

In an embodiment, a combination of the first charging identifier and the network function instance identifier of the second SMF are used as an identifier of a charging data record.

In an embodiment, the method further comprises allocating a second charging identifier for the PDU session. The method further comprises sending an initial charging data request comprising the second charging identifier to the first charging function.

In an embodiment, the first charging data request further comprises the second charging identifier.

In an embodiment, the first charging identifier, the second charging identifier and the network function instance identifier of the second SMF are used as an identifier of a charging data record.

In an embodiment, the first charging identifier for the PDU session is received from the second SMF during at least one of an evolved packet system (EPS) to fifth generation system (5GS) idle mode mobility, a handover of a home-routed PDU session, or a PDU session establishment procedure of a home-routed PDU session.

In an embodiment, the network function instance identifier of the second SMF is comprised in PDU session information.

In an embodiment, the first SMF is a visited SMF, the second SMF is a home SMF and the first charging function is a visited charging function.

In a second aspect of the disclosure, there is provided a method performed by a second SMF. The method comprises, during a protocol data unit (PDU) session establishment procedure of a home-routed PDU session, receiving a PDU session create request from a first SMF. The method further comprises allocating a first charging identifier for the PDU session. The method further comprises sending a PDU session create response comprising the first charging identifier for the PDU session to the first SMF.

In an embodiment, a combination of the first charging identifier and a network function instance identifier of the second SMF are used as an identifier of a charging data record.

In an embodiment, the method further comprises sending a charging data request comprising the first charging identifier to a second charging function.

In an embodiment, the second charging function is a home charging function.

In an embodiment, the first SMF is a visited SMF and the second SMF is a home SMF.

In a third aspect of the disclosure, there is provided a method performed by a first charging function. The method comprises receiving from a first session management function (SMF) a first charging data request comprising a first charging identifier for a protocol data unit (PDU) session and a network function instance identifier of a second SMF. The first charging identifier is allocated by the second SMF. The method further comprises updating a charging data record based on the first charging data request.

In an embodiment, a combination of the first charging identifier and the network function instance identifier of the second SMF are used as an identifier of a charging data record.

In an embodiment, the first charging identifier is allocated by the second SMF.

In an embodiment, the method further comprises receiving an initial charging data request comprising a second charging identifier for the PDU session from the first SMF. The second charging identifier is allocated by the first SMF. The method further comprises opening the charging data record based on the initial charging data request.

In an embodiment, the first charging data request further comprises the second charging identifier.

In an embodiment, the first charging identifier, the second charging identifier and the network function instance identifier of the second SMF are used as an identifier of a charging data record.

In an embodiment, the network function instance identifier of the second SMF is comprised in PDU session information.

In an embodiment, the first SMF is a visited SMF, the second SMF is a home SMF and the first charging function is a visited charging function.

In a fourth aspect of the disclosure, there is provided a first SMF. The first SMF comprises a processor and a memory coupled to the processor. Said memory contains instructions executable by said processor. Said first SMF is operative to send a protocol data unit (PDU) session create request to a second SMF. Said first SMF is further operative to receive a PDU session create response comprising a first charging identifier for the PDU session from a second SMF. Said first SMF is further operative to send to a first charging function a first charging data request comprising the first charging identifier and a network function instance identifier of the second SMF.

In a fifth aspect of the disclosure, there is provided a second SMF. The second SMF comprises a processor and a memory coupled to the processor. Said memory contains instructions executable by said processor. Said second SMF is operative to, during a protocol data unit (PDU) session establishment procedure of a home-routed PDU session, receive a PDU session create request from a first SMF. Said second SMF is further operative to allocate a first charging identifier for the PDU session. Said second SMF is further operative to send a PDU session create response comprising the first charging identifier for the PDU session to the first SMF.

In a sixth aspect of the disclosure, there is provided a first charging function. The first charging function comprises a processor and a memory coupled to the processor. Said memory contains instructions executable by said processor. Said first charging function is operative to receive from a first session management function (SMF) a first charging data request comprising a first charging identifier for a protocol data unit (PDU) session and a network function instance identifier of a second SMF. The first charging identifier is allocated by the second SMF. Said first charging function is operative to update a charging data record based on the first charging data request.

In a seventh aspect of the disclosure, there is provided a first SMF. The first SMF comprises a first sending module configured to send a protocol data unit (PDU) session create request to a second SMF. The first SMF further comprises a receiving module configured to receive a PDU session create response comprising a first charging identifier for the PDU session from a second SMF. The first SMF further comprises a second sending module configured to send to a first charging function a first charging data request comprising the first charging identifier and a network function instance identifier of the second SMF.

In an embodiment, the first SMF further comprises an allocating module configured to allocate a second charging identifier for the PDU session.

In an embodiment, the first SMF further comprises a third sending module configured to send an initial charging data request comprising the second charging identifier to the first charging function.

In an eighth aspect of the disclosure, there is provided a second SMF. The second SMF comprises a receiving module configured to, during a protocol data unit (PDU) session establishment procedure of a home-routed PDU session, receive a PDU session create request from a first SMF. The second SMF further comprises an allocating module configured to allocate a first charging identifier for the PDU session. The second SMF further comprises a first sending module configured to send a PDU session create response comprising the first charging identifier for the PDU session to the first SMF.

In an embodiment, the second SMF further comprises a second sending module configured to send a charging data request comprising the first charging identifier to a second charging function.

In a ninth aspect of the disclosure, there is provided a first charging function. The first charging function comprises a first receiving module configured to receive from a first session management function (SMF) a first charging data request comprising a first charging identifier for a protocol data unit (PDU) session and a network function instance identifier of a second SMF. The first charging identifier is allocated by the second SMF. The first charging function comprises an updating module configured to update a charging data record based on the first charging data request.

In an embodiment, the first charging function further comprises a second receiving module configured to receive an initial charging data request comprising a second charging identifier for the PDU session from the first SMF. The second charging identifier is allocated by the first SMF.

In an embodiment, the first charging function further comprises an opening module configured to open the charging data record based on the initial charging data request.

In another aspect of the disclosure, there is provided a computer program product comprising instructions which when executed by at least one processor, cause the at least one processor to perform the method according to any one of the first or second or third aspects.

In another aspect of the disclosure, there is provided a computer-readable storage medium storing instructions which when executed by at least one processor, cause the at least one processor to perform the method according to any one of the first or second or third aspects.

Embodiments herein may provide many advantages, of which a non-exhaustive list of examples follows. In some embodiments herein, it can make the charging ID uniqueness in billing system. In some embodiments, it can simplify the charging ID generation and reporting. In some embodiments herein, it can avoid charging ID collision between SMFs. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows 5G system roaming architecture in the case of home routed scenario using the reference point representation according to an embodiment of the present disclosure;

FIG. 2 shows a flowchart of charging ID collision in H-CHF according to an embodiment of the present disclosure;

FIG. 3 shows a flowchart of charging ID collision in V-CHF according to an embodiment of the present disclosure;

FIG. 4 shows a flowchart of a method according to an embodiment of the present disclosure;

FIG. 5 shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 7a shows a flowchart of a method according to another embodiment of the present disclosure;

FIG. 7b shows a flowchart of a method according to another embodiment of the present disclosure;

FIG. 7c shows a flowchart of a PDU session charging establishment in roaming home routed scenario according to another embodiment of the present disclosure;

FIG. 8a is a block diagram showing an apparatus suitable for practicing some embodiments of the disclosure;

FIG. 8b is a block diagram showing a first SMF according to an embodiment of the disclosure;

FIG. 8c is a block diagram showing a second SMF according to an embodiment of the disclosure;

FIG. 8d is a block diagram showing a first charging function according to an embodiment of the disclosure;

FIG. 9 shows an example of a communication system according to an embodiment of the disclosure;

FIG. 10 is a block diagram of a host according to an embodiment of the disclosure; and

FIG. 11 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

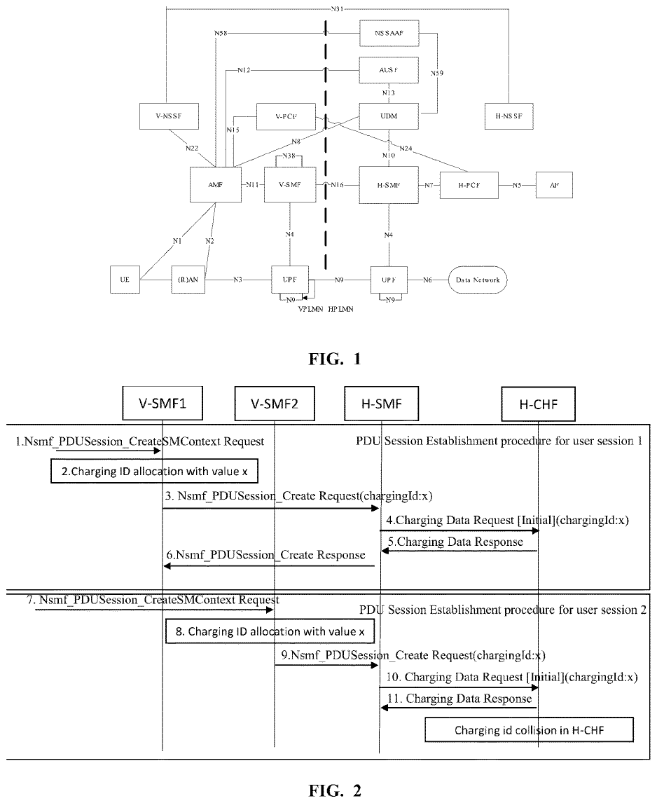

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 1 schematically shows 5G system roaming architecture in the case of home routed scenario using the reference point representation according to an embodiment of the present disclosure. The architecture of FIG. 1 is same as FIG. 4.2.4-6 as described in 3GPP TS 23.501 V18.0.0, the disclosure of which is incorporated by reference herein in its entirety. The system architecture of FIG. 1 may comprise some exemplary elements such as AUSF, AMF, data network, visited NSSF (V-NSSF), home NSSF (H-NSSF), visited PCF (V-PCF), visited SMF (V-SMF), home SMF (H-SMF), UDM, UPF, AF, UE, (R) AN, NSSAAF (Network Slice-Specific Authentication and Authorization Function), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the data network (e.g. an operator network or Internet) through the UPF over the reference point N6.

The N38 references point can be between V-SMFs in the same VPLMN, or between V-SMFs in different VPLMNs (to enable inter-PLMN mobility).

For the roaming scenarios described above each PLMN implements proxy functionality to secure interconnection and hide topology on the inter-PLMN interfaces.

As further illustrated in FIG. 1, it also shows some reference points such as N1, N2, N3, N4, N6, N9, N11, N38, N16, N7, N5, N22, N15, N8, N24, N10, N58, N12, N31, N59, N13 etc., which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 1 may be responsible for functions such as session management, mobility management, authentication, security, etc. Various NFs shown in FIG. 1 may include the functionality for example as defined in clause 6.2 of 3GPP TS 23.501 V18.0.0.

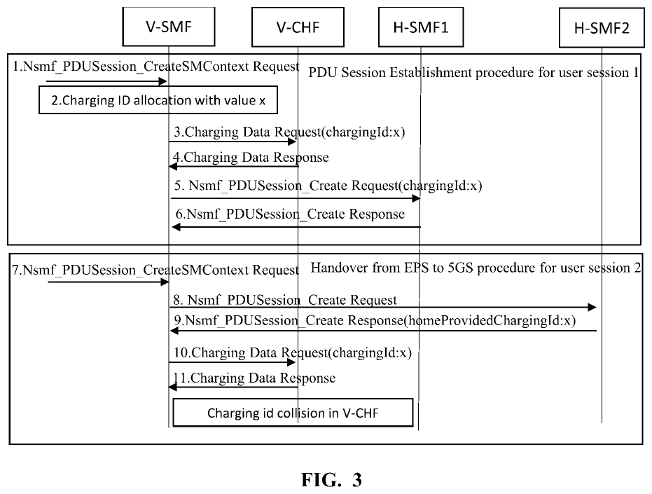

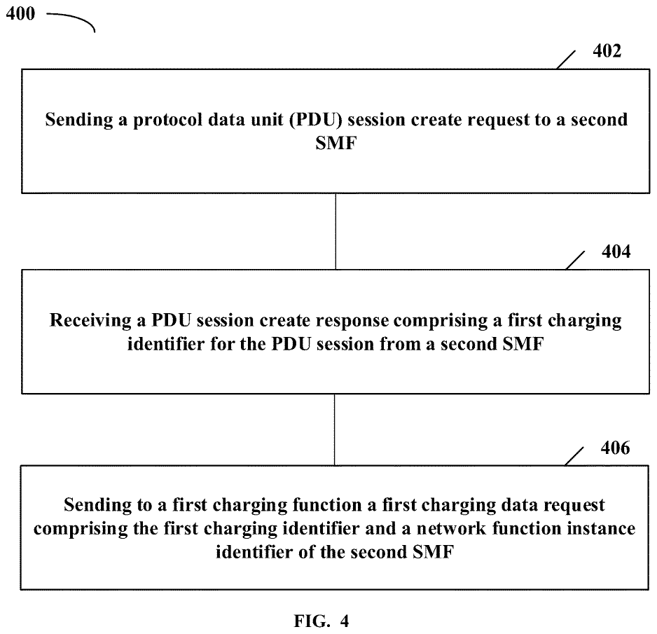

FIGS. 2 and 3 show some examples of problems for the exiting charging solutions.

FIG. 2 shows a flowchart of charging ID collision in H-CHF according to an embodiment of the present disclosure.

PDU Session Establishment procedure for user session 1.
Step 1. V-SMF1 receives an Nsmf_PDUSession_CreateSMContext Request.
Step 2. V-SMF1 allocates a charging ID with value x.
Step 3. V-SMF1 sends an Nsmf_PDUSession_Create Request (chargingId:x) to H-SMF.
Step 4. H-SMF sends a Charging Data Request [Initial] (chargingId:x) to a home Charging Function (H-CHF).
Step 5. H-SMF receives a Charging Data Response from H-CHF.
Step 6. H-SMF sends an Nsmf_PDUSession_Create Response to V-SMF1.

PDU Session Establishment procedure for user session 2
Step 7. V-SMF2 receives an Nsmf_PDUSession_CreateSMContext Request.
Step 8. V-SMF2 allocates a charging ID with value x.
Step 9. V-SMF2 sends an Nsmf_PDUSession_Create Request (chargingId:x) to H-SMF.
Step 10. H-SMF sends a Charging Data Request [Initial] (chargingId:x) to H-CHF.
Step 11. H-SMF receives a Charging Data Response from H-CHF.

The same charging ID is used by V-SMF1 and V-SMF2. And the same charging ID is transferred to the H-SMF. The H-SMF sends different Charging Data Requests [Initial] with the same chargingId:x for different PDU sessions to H-CHF. Therefore charging ID collision occurs in H-CHF.

The messages of FIG. 2 may be same as the corresponding messages as described in various 3GPP specifications such as 3GPP TS 29.502 V18.1.0, 3GPP TS 23.502 V18.0.0, 3GPP TS 32.255 V17.8.0, etc.

FIG. 3 shows a flowchart of charging ID collision in V-CHF according to an embodiment of the present disclosure.

PDU Session Establishment procedure for user session 1
Step 1.V-SMF receives an Nsmf_PDUSession_CreateSMContext Request
Step 2. V-SMF allocates a charging ID with value x.
Step 3. V-SMF sends a Charging Data Request (chargingId:x) to a visited CHF (V-CHF).
Step 4. V-SMF receives a Charging Data Response from V-CHF.
Step 5. V-SMF sends an Nsmf_PDUSession_Create Request (chargingId:x) to H-SMF1.
Step 6. V-SMF receives an Nsmf_PDUSession_Create Response from H-SMF1.

Handover from EPS to 5GS procedure for user session 2
Step 7. V-SMF receives an Nsmf_PDUSession_CreateSMContext Request.
Step 8. V-SMF sends an Nsmf_PDUSession_Create Request to H-SMF2.
Step 9. V-SMF receives an Nsmf_PDUSession_Create Response (homeProvidedChargingId:x) from H-SMF2.
Step 10. V-SMF sends a Charging Data Request (chargingId:x) to a visited CHF.
Step 11. V-SMF receives a Charging Data Response from V-CHF.

The same charging ID is used by V-SMF and H-SMF2. And the same charging ID is transferred to the V-SMF from the H-SMF. The V-SMF sends different Charging Data Requests [Initial] with the same chargingId:x for different PDU sessions to V-CHF. Therefore charging ID collision occurs in V-CHF.

The messages of FIG. 3 may be same as the corresponding messages as described in various 3GPP specifications such as 3GPP TS 29.502 V18.1.0, 3GPP TS 23.502 V18.0.0, 3GPP TS 32.255 V17.8.0, etc.

FIG. 4 shows a flowchart of a method according to an embodiment of the present disclosure, which may be performed by an apparatus implemented in or at or as a first session management function (SMF) or communicatively coupled to the first SMF. As such, the apparatus may provide means or modules for accomplishing various parts of the method 400 as well as means or modules for accomplishing other processes in conjunction with other components.

At block 402, the first SMF may send a protocol data unit (PDU) session create request to a second SMF.

The first SMF may be any suitable network device or node or entity or function which can provide session management function. In an embodiment, the first SMF may be an intermediate SMF (I-SMF) or a visited SMF (V-SMF) as described in 3GPP TS 23.501 V18.0.0.

For example, the I-SMF may be an SMF that is inserted to support a PDU session as the UE is located in an area which cannot be controlled by the original SMF because the UPF(s) belong to a different SMF service area. For example, the V-SMF may be an SMF that is inserted to support a PDU session as the UE is located in a visited network which cannot be controlled by the home SMF because the UPF(s) belong to the visited network.

The second SMF may be any suitable network device or node or entity or function which can provide session management function. In an embodiment, the second SMF may be an SMF or a Packet Data Network Gateway control plane (PGW-C) combined with SMF (PGW-C+SMF) or a home SMF or anchor SMF (A-SMF) as described in 3GPP TS 23.501 V18.0.0. For example, the H-SMF may be an SMF that is located in a home network.

In an embodiment, the first SMF is a visited SMF and the second SMF is a home SMF.

In an embodiment, the PDU session create request may be the Nsmf_PDUSession_Create Request as described in 3GPP TS 23.502 V18.0.0 and 3GPP TS 32.255 V17.8.0, etc.

For example, the PDU session create request may be sent to the second SMF during an evolved packet system (EPS) to fifth generation system (5GS) idle mode mobility, a handover of a home-routed PDU session, or a PDU session establishment procedure of a home-routed PDU session as described in 3GPP TS 23.502 V18.0.0 and 3GPP TS 32.255 V17.8.0, etc.

At block 404, the first SMF may receive a PDU session create response comprising a first charging identifier for the PDU session from a second SMF.

In an embodiment, the PDU session create response may be the Nsmf_PDUSession_Create Response as described in 3GPP TS 23.502 V18.0.0 and 3GPP TS 32.255 V17.8.0, etc.

For example, the PDU session create response may be received from the second SMF during an evolved packet system (EPS) to fifth generation system (5GS) idle mode mobility, a handover of a home-routed PDU session, or a PDU session establishment procedure of a home-routed PDU session as described in 3GPP TS 23.502 V18.0.0 and 3GPP TS 32.255 V17.8.0, etc.

The first charging identifier may be any suitable identifier. The first charging identifier may be created to allow correlation of charging information. In an embodiment, the first charging identifier may be Home Provided Charging Id as described in 3GPP TS 32.255 V17.8.0.

As described in clause 5.1.4 of 3GPP TS 32.255 V17.8.0, for the SMF the charging identifier is assigned per PDU session including the case of I-SMF insertion. At each PDU session establishment, i.e. assignment of a new PDU session ID, a new PDU session specific SMF Charging Identifier is generated at the first SMF that processes the PDU session initiating request. The SMF Charging Identifier shall be unique within the SMF (that means that the charging identifier is unique within the SMF set if SMF set is used) which assigned it and is then used in all subsequent messages for that PDU session. The Charging Identifier shall be used throughout the PDU session's lifetime once assigned. In case of inter-system changes or handovers of PDU session, the Charging Identifier is preserved as long as the PDU session Identifier is preserved.

In an embodiment, the first charging identifier may be present during an EPS to 5GS Idle mode mobility or Handover of a HR PDU session. In an embodiment, the first charging identifier may be present during PDU session establishment procedure of a HR PDU session.

In an embodiment, the chargingId information element (IE) in SmContext (see clause 6.1.6.2.39 of 3GPP TS 32.255 V17.8.0) may be set to the value received in the homeProvidedChargingId IE during an EPS to 5GS Idle mode mobility or Handover of a HR PDU session or PDU session establishment procedure of a HR PDU session.

In an embodiment, at each PDU session establishment, i.e. assignment of a new PDU session ID, a new PDU session specific SMF Charging Identifier is generated at the SMF in the H-PLMN and transferred to the SMF in the V-PLMN.

At block 406, the first SMF may send to a first charging function a first charging data request comprising the first charging identifier and a network function instance identifier of the second SMF.

The first charging function may be any suitable network device or node or entity or function which can provide charging function. In an embodiment, the first charging function may be a visited charging function as described in 3GPP TS 23.501 V18.0.0 and 3GPP TS 32.255 V17.8.0.

In an embodiment, the first SMF is a visited SMF, the second SMF is a home SMF and the first charging function is a visited charging function.

In an embodiment, the first charging data request may be Charging Data Request as described in 3GPP TS 32.255 V17.8.0. For example, the first charging data request that includes the first charging identifier allocated by the second SMF can be type of [update and termination]. For example, the first charging data request that includes the first charging identifier allocated by the second SMF can be type of [Initial]. The Charging Data Request [Initial], the Charging Data Request [Update] and the Charging Data Request [Termination] are described in 3GPP TS 32.255 V17.8.0. The default trigger conditions in SMF for these Charging Data Requests are also are described in 3GPP TS 32.255 V17.8.0.

In an embodiment, the first charging data request may be sent to the first charging function during at least one of an evolved packet system (EPS) to fifth generation system (5GS) idle mode mobility, a handover of a home-routed PDU session, or a PDU session establishment procedure of a home-routed PDU session.

In an embodiment, the network function instance identifier of the second SMF may be the NF Instance identifier of the SMF in H-PLMN.

In an embodiment, a combination of the first charging identifier and the network function instance identifier of the second SMF may be used as an identifier of a charging data record.

In an embodiment, the network function instance identifier of the second SMF may be comprised in PDU session information as described in clause 6.1.6.2.2.8 of 3GPP TS 32.291 V18.0.0, the disclosure of which is incorporated by reference herein in its entirety.

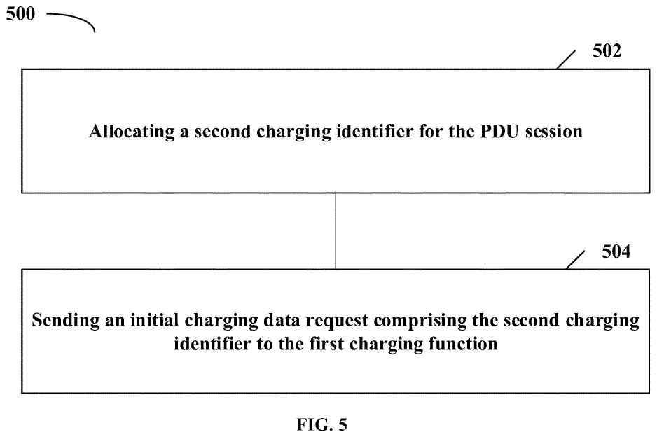

FIG. 5 shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the first SMF may allocate a second charging identifier for the PDU session. For example, at each PDU session establishment, i.e. assignment of a new PDU session ID, a new PDU session specific SMF Charging Identifier is generated at the first SMF that processes the PDU session initiating request.

In an embodiment, the first SMF such as V-SMF may allocate the second charging identifier for the PDU session during at least one of an evolved packet system (EPS) to fifth generation system (5GS) idle mode mobility, a handover of a home-routed PDU session, or a PDU session establishment procedure of a home-routed PDU session.

At block 504, the first SMF may send an initial charging data request comprising the second charging identifier to the first charging function.

In an embodiment, the initial charging data request may be Charging Data Request as described in 3GPP TS 32.255 V17.8.0. For example, the initial charging data request may be of type [Initial]. The Charging Data Request [Initial] is described in 3GPP TS 32.255 V17.8.0. The default trigger conditions in SMF for the Charging Data Request [Initial] are also are described in 3GPP TS 32.255 V17.8.0.

In an embodiment, blocks 502 and 504 may be performed before blocks 402, 404 and 406 of FIG. 4.

In an embodiment, the first charging data request may further comprise the second charging identifier.

In an embodiment, the first charging identifier, the second charging identifier and the network function instance identifier of the second SMF are used as an identifier of a charging data record.

In an embodiment, this Home Provided Charging Id may or shall be used by the V-SMF together with the charging ID (V-SMF created charging ID) in the subsequence charging data request message.

In an embodiment, for EPS handover 5GS in Home routed scenario, the Charging Identifier for the EPS Packet Data Network (PDN) connection will be generated by PGW-C+SMF in HPLMN and transferred to the SMF in VPLMN.

In an embodiment, if the V-SMF has already generated the Charging Identifier, the Home Provided Charging Id may be used by the V-SMF together with the charging ID (V-SMF created charging ID) in the subsequence charging data request message.

In an embodiment, in home routed scenario, a parameter exchanged at PDU session establishment is the Home Provided Charging Id which includes the Charging Id assigned by the H-SMF and transferred by the H-SMF to the V-SMF. This Home Provided Charging Id may be used by the V-SMF together with the charging ID (V-SMF created charging ID) in the subsequence charging data request message.

In an embodiment, in home routed scenario, a parameter exchanged during the PDU session handover from EPS to 5GS is the Home Provided Charging Id which includes the Charging Id assigned by the H-SMF to the original PDU session over EPS and transferred by the H-SMF to the V-SMF. This Home Provided Charging Id may be used by the V-SMF together with the charging ID (V-SMF created charging ID) in the subsequence charging data request message.

In an embodiment, during PDU session establishment, a Charging Data Request [Initial] may be sent to CHF, indicating “in-bound roamer”. SMF in VPLMN creates a charging ID (V-SMF created Charging Id) for the PDU session and sends the Charging Data Request [Initial] to CHF in VPLMN. H-SMF may send an Nsmf_PDUSession_Create Response to V-SMF with charging Id (Home provided charging ID). Based on “received PDU session conditions” trigger, a Charging Data Request [Update] is sent to CHF with charging information received from H-SMF, which includes the HPLMN selected “Roaming Charging Profile” and counts per QoS Flow Identifier (QFI) are started and charging ID (Visited created Charging Id) and home provided charging ID.

In an embodiment, the first charging identifier for the PDU session is received from the second SMF during at least one of an evolved packet system (EPS) to fifth generation system (5GS) idle mode mobility, a handover of a home-routed PDU session, or a PDU session establishment procedure of a home-routed PDU session.

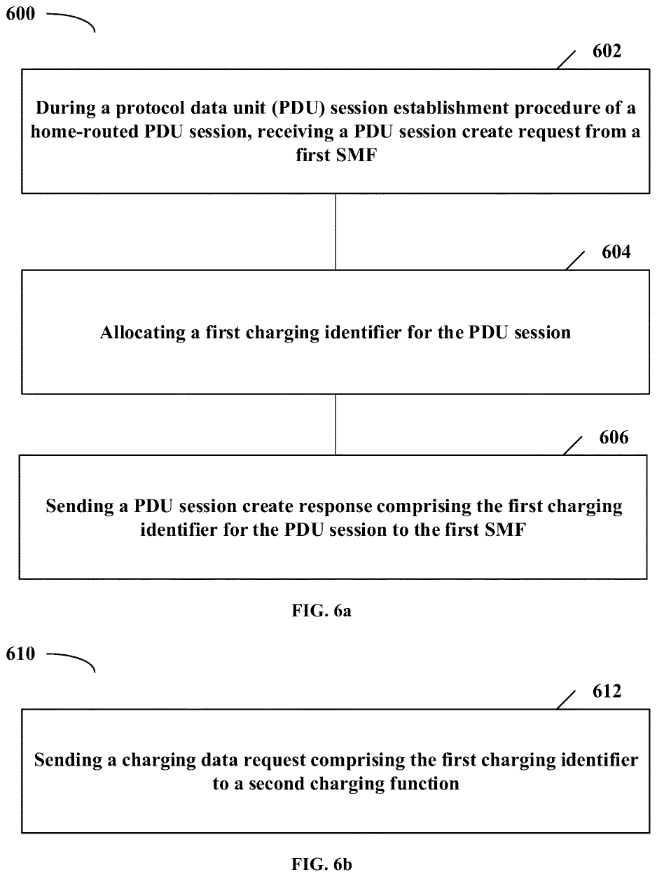

FIG. 6a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, during a protocol data unit (PDU) session establishment procedure of a home-routed PDU session, the second SMF may receive a PDU session create request from a first SMF.

In an embodiment, the first SMF is a visited SMF and the second SMF is a home SMF.

At block 604, the second SMF may allocate a first charging identifier for the PDU session.

At block 606, the second SMF may send a PDU session create response comprising the first charging identifier for the PDU session to the first SMF.

In an embodiment, a combination of the first charging identifier and a network function instance identifier of the second SMF are used as an identifier of a charging data record.

FIG. 6b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 610 as well as means or modules for accomplishing other processes in conjunction with other components. For some parts which have been described in the above embodiments, the description thereof is omitted here for brevity.

At block 612, the second SMF may send a charging data request comprising the first charging identifier to a second charging function.

The second charging function may be any suitable network device or node or entity or function which can provide charging function. In an embodiment, the second charging function may be a home charging function e.g. as described in 3GPP TS 23.501 V18.0.0 and 3GPP TS 32.255 V17.8.0.

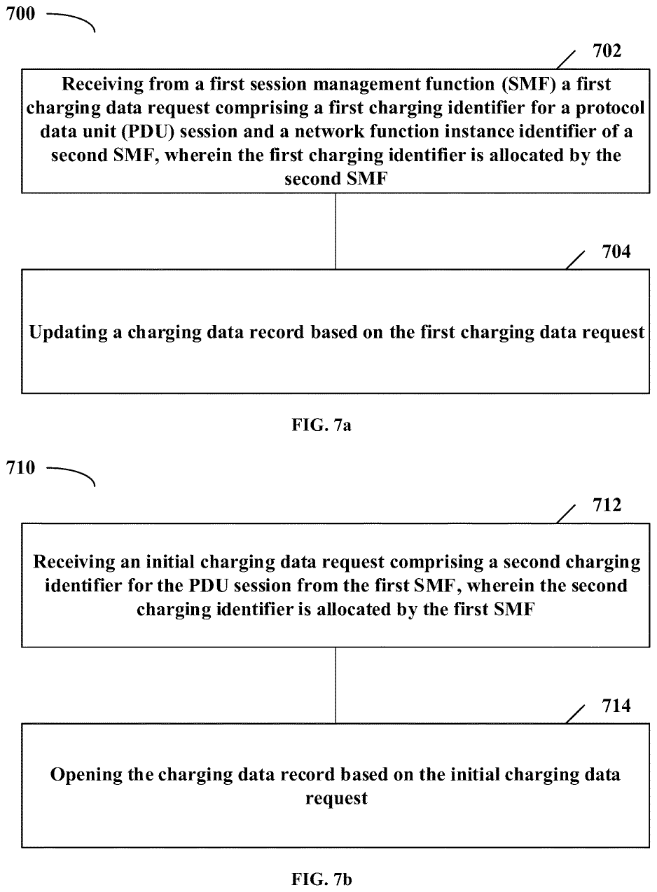

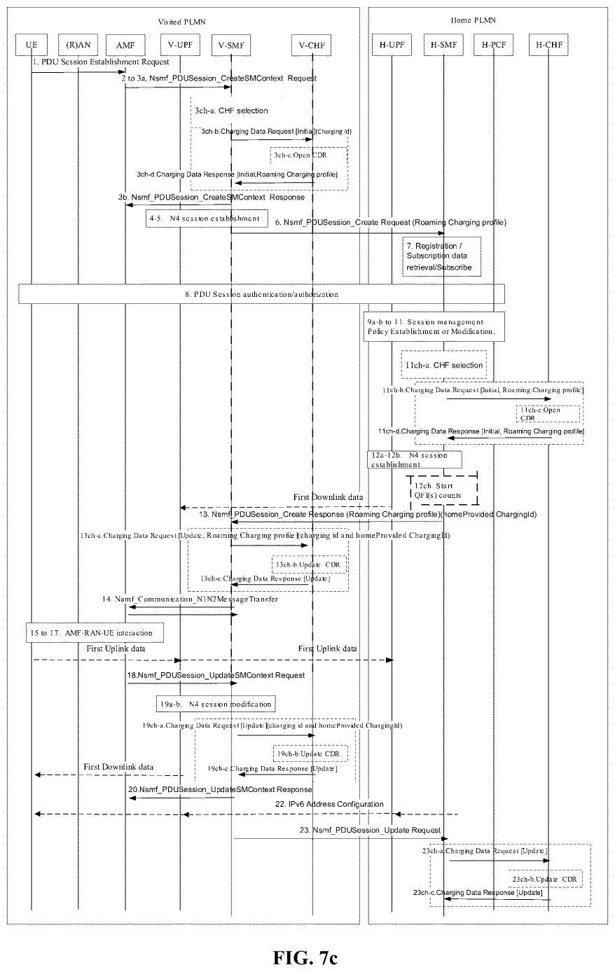

FIG. 7a shows a flowchart of a method according to another embodiment of the present disclosure, which may be performed by an apparatus implemented in or at or as a first charging function or communicatively coupled to the first charging function. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the first charging function may receive from a first session management function (SMF) a first charging data request comprising a first charging identifier for a protocol data unit (PDU) session and a network function instance identifier of a second SMF. The first charging identifier is allocated by the second SMF.

At block 704, the first charging function may update a charging data record based on the first charging data request.

In an embodiment, the first charging function may open a charging data record based on the first charging data request if the charging data record is not opened before or the first charging data request is an initial charging data request.

In an embodiment, a combination of the first charging identifier and the network function instance identifier of the second SMF are used as an identifier of a charging data record.

In an embodiment, the first charging identifier is allocated by the second SMF.

FIG. 7b shows a flowchart of a method according to another embodiment of the present disclosure, which may be performed by an apparatus implemented in or at or as a first charging function or communicatively coupled to the first charging function. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 712, the first charging function may receive an initial charging data request comprising a second charging identifier for the PDU session from the first SMF.

In an embodiment, the second charging identifier is allocated by the first SMF.

At block 714, the first charging function may open the charging data record based on the initial charging data request.

In an embodiment, the first charging data request further comprises the second charging identifier.

In an embodiment, the first charging identifier, the second charging identifier and the network function instance identifier of the second SMF are used as an identifier of a charging data record.

In an embodiment, the network function instance identifier of the second SMF is comprised in PDU session information.

In an embodiment, the first SMF is a visited SMF, the second SMF is a home SMF and the first charging function is a visited charging function.

FIG. 7c shows a flowchart of a PDU session charging establishment in roaming home routed scenario according to another embodiment of the present disclosure.
Steps 1-3a. UE initiates a new PDU session. V-SMF and H-SMF selection is performed by the AMF.
Step 1. UE sends a PDU Session Establishment Request to AMF.
Step 2 to 3a. AMF sends an Nsmf_PDUSession_CreateSMContext Request to V-SMF.
Step 3ch-a. V-SMF performs CHF selection. The UE is identified as a roamer (PLMN ID of the received SUPI (Subscription Permanent Identifier) is different from VPLMN PLMN ID), the CHF is selected accordingly (the V-SMF may include 5GS Cellular Internet of Things (CIoT) related information).
Step 3ch-b. V-SMF sends a Charging Data Request [Initial] (Charging Id) to V-CHF. A Charging Data Request [Initial] is sent to CHF, indicating “in-bound roamer”. The SMF in V-PLMN allocates a charging ID (Visited created Charging Id) and use it when communicate with V-CHF.
Step 3ch-c. V-CHF opens a CDR (indicating “in-bound roamer”).
Step 3ch-d. V-CHF sends a Charging Data Response [Initial, Roaming Charging profile] to V-SMF. The V-CHF acknowledges by sending Charging Data Response [Initial] to the SMF and optionally supplies a “Roaming Charging Profile” to the V-SMF which overrides the default one.
Step 3b. V-SMF sends Nsmf_PDUSession_CreateSMContext Response to AMF.
Step 4-5. N4 session establishment is performed between V-UPF and V-SMF.
Step 6. V-SMF sends Nsmf_PDUSession_Create Request (Roaming Charging profile) to H-SMF. The SMF in V-PLMN does not include the ChargingId allocated in step 3ch to the SMF in H-PLMN.
Step 7. H-SMF performs Registration/Subscription data retrieval/Subscribe.
Step 8. PDU Session authentication/authorization.
Step 9a-b to 11. Session management Policy Establishment or Modification. H-SMF performs UPF selection (not shown).
Step 11ch-a.H-SMF performs CHF selection. Based on UE is identified as roaming in a different PLMN, the CHF is selected accordingly.
Step 11ch-b. H-SMF sends a Charging Data Request [Initial, Roaming Charging profile] to H-CHF. A Charging Data Request [Initial] is sent to CHF, indicating “out-bound roamer”, with the “Roaming Charging Profile” received from the VPLMN (the H-SMF may include 5GS CIoT related information). The SMF in the H-PLMN may or shall allocate session level charging Id and use it when communicate with H-CHF.
Step 11ch-c. The CHF opens a CDR (indicating “out-bound roamer”).
Step 11ch-d. H-CHF sends a Charging Data Response [Initial, Roaming Charging profile] to H-SMF. The CHF acknowledges by sending Charging Data Response [Initial] to the H-SMF and supplies the HPLMN selected “Roaming Charging Profile” (either the same as the one received from VPLMN, either its own selected) to the H-SMF.
Step 12a-12b. N4 session establishment is performed between H-UPF and H-SMF.

The SMF initiates an N4 Session Establishment procedure with the selected UPF. Step 12ch. H-SMF starts QFI(s) counts. Counts per QFI are started.

H-UPF sends First Downlink data to V-UPF.
Step 13. H-SMF sends an Nsmf_PDUSession_Create Response (Roaming Charging profile) (homeProvided ChargingId) to V-SMF. The SMF in H-PLMN may or shall provision the session level charging Id to the V-SMF via the Home Provided Charging Id.
Step 13ch-a. V-SMF sends a Charging Data Request [Update, Roaming Charging profile] (charging id and homeProvided ChargingId) to V-CHF. Based on “received PDU session conditions” trigger, a Charging Data Request [Update] is sent to CHF with charging information received from H-SMF, which includes the HPLMN selected “Roaming Charging Profile” and counts per QFI are started. This Home Provided Charging Id may or shall be used by the V-SMF together with the charging ID (visited created charging ID) in the subsequence charging data request message.

The V-SMF can include hSMF Nfinstance in the Charging Data Request message sent to the V-CHF to assistant V-CHF to form a unique identifier of the charging data record.
Step 13ch-b. V-CHF updates CDR.
Step 13ch-c. V-CHF sends a Charging Data Response [Update] to V-SMF. The CHF acknowledges by sending Charging Data Response [Update] to the V-SMF.
Step 14. V-SMF sends an Namf_Communication_NIN2MessageTransfer to AMF and receives a response from AMF.
Step 15 to 17. AMF-RAN-UE interaction.

UE sends First Uplink data to V-UPF which send it to H-UPF.
Step 18. AMF sends an Nsmf_PDUSession_UpdateSMContext Request to V-SMF.
Step 19a-b. N4 session modification between V-UPF and V-SMF.
Step 19ch-a. V-SMF sends an Charging Data Request [Update] (charging id and homeProvided ChargingId) to V-CHF. Counts per rejected QFI(s) are closed. A Charging Data Request [Update] is sent to CHF to report if needed.
Step 19ch-b. V-CHF updates CDR.
Step 19ch-c. V-CHF sends a Charging Data Response [Update] to V-SMF. The CHF acknowledges by sending Charging Data Response [Update] to the V-SMF.

V-UPF sends First Downlink data to UE.
Step 20. V-SMF sends an Nsmf_PDUSession_UpdateSMContext Response to AMF.
Step 22. IPv6 Address Configuration.
Step 23. V-SMF sends an Nsmf_PDUSession_Update Request to H-SMF. Nsmf_PDUSession_UpdateRequest from V-SMF to H-SMF. The rejected QFI(s) are notified to H-SMF.
Step 23ch-a. H-SMF sends Charging Data Request [Update] to H-CHF. Counts per rejected QFI(s) are closed. A Charging Data Request [Update] is sent to CHF to report if needed.
Step 23ch-b. H-CHF updates CDR.
Step 23ch-c. H-CHF sends a Charging Data Response [Update] to H-SMF. The CHF acknowledges by sending Charging Data Response [Update] to the H-SMF.

Some messages of FIG. 7c may be same as the corresponding messages as described in various 3GPP specifications such as 3GPP TS 29.502 V18.1.0, 3GPP TS 23.502 V18.0.0, 3GPP TS 32.255 V17.8.0, etc. Some messages and operations (such as steps 3ch-b, 6, Step 11ch, 13, 13ch and 19ch-a) of FIG. 7c may be enhanced by the embodiments of the present disclosure.

In an embodiment, in home routed scenario, the charging ID is generated by the H-SMF.

In an embodiment, during the PDU session establishment procedure, the SMF in V-PLMN may create a charging ID (Visited created Charging Id) for the PDU session and sends the Charging Data Request [Initial] to CHF in V-PLMN.

In an embodiment, during the PDU session establishment procedure, the SMF in H-PLMN may generate a charging ID and provision it to the V-SMF side via the Home Provided Charging Id. This Home Provided Charging Id may be used by the V-SMF together with the charging ID generated by the SMF in V-PLMN when communicate with the V-CHF. The V-CHF can use the combination of V-PLMN generated charging ID and home provided charging ID to unique identify a Charging record.

In an embodiment, the charging Id generated by the SMF in H-PLMN may be with 32-bit unsigned integer value.

In an embodiment, it may add a new attribute of H-SMF instance id in N40 interface to assist the V-CHF using a combination of charging Id (such as the home provided charging ID or a combination of home provided charging ID and visited created charging ID) and H-SMF instance ID as a unique identifier.

In an embodiment, homeProvidedChargingId can be provisioned by the H-SMF to the V-SMF during the PDU session establishment procedure.

In an embodiment, homeProvidedChargingId and NOTE 5 of Table 6.1.6.2.10-1 of 3GPP TS 29.502 V18.1.0 may be amended as following.

TABLE 6.1.6.2.10-1
Definition of type PduSessionCreatedData

| | | | | | |
|---|---|---|---|---|---|
| | Data | | | | |
| Attribute name | type | P | Cardinality | Description | Applicability |

| | | | | |
|---|---|---|---|---|
| homeProvidedChargingId | string | O | 0 . . . 1 | When present, this IE may or shall contain the Home |
| | | | | provided Charging ID (see 3GPP TS 32.255 [25]). |
| | | | | This IE may or shall be present during an EPS to 5GS Idle |
| | | | | mode mobility or Handover of a HR PDU session. |
| | | | | This IE may or shall be present during PDU session |
| | | | | establishment procedure of a HR PDU session. (NOTE 5) |
| | | | | The string may or shall encode the Charging ID (32-bit |
| | | | | unsigned integer value, with maximum value |
| | | | | “4294967295”) in decimal representation. |
| | | | | Pattern: ‘\hat{ }(0\|([1-9]{1}[0-9]{0, 9}))$’ |
| | | | | (NOTE 8) |

(NOTE 5):
The chargingId IE in SmContext (see clause 6.1.6.2.39) may or shall be set to the value received in the homeProvidedChargingId IE during an EPS to 5GS Idle mode mobility or Handover of a HR PDU session or PDU session establishment procedure of a HR PDU session.

In an embodiment, it may add hSMF Nfinstance Id in the PDUSessionInforamtion attribute. The combination of hSMFId and the charging ID (such as the home provided charging ID or a combination of home provided charging ID and visited created charging ID) can be a unique identifier of the charging data record in the V-CHF.

In an embodiment, Table 6.1.6.2.2.8-1 of 3GPP TS 32.291 V18.0.0 may add hSMF Nfinstance Id.

TABLE 6.1.6.2.2.8-1
Definition of type PDUSessionInformation

| | | | | | |
|---|---|---|---|---|---|
| Attribute name | Data type | P | Cardinality | Description | Applicability |

| | | | | |
|---|---|---|---|---|
| hSmfID | NfInstanceId | O_{C} | 0 . . . 1 | NFInstance identifier of the |
| | | | | SMF in H-PLMN e.g. used |
| | | | | by V-SMF for HR roaming. |

In an embodiment, sMFChargingId and sMFHomeProvidedChargingId of Table 6.1.6.2.2.6-1 of 3GPP TS 32.291 V18.0.0 may be amended as following. Both U32 based and string based charging ID can be present in N40 interface.

TABLE 6.1.6.2.2.6-1
Definition of type PDUSessionChargingInformation

| Attribute name | Data type | P | Cardinality | Description | Applicability |
|---|---|---|---|---|---|
| chargingId | ChargingId | O_{M} | 0 . . . 1 | Charging identifier for correlation | |
| | | | | between different records of a | |
| | | | | single PDU session | |
| sMFChargingId | string | O_{M} | 0 . . . 1 | Used when feature is active. | SMF_Charging_Id |
| homeProvidedChargingId | ChargingId | O_{C} | 0 . . . 1 | Charging identifier for correlation | |
| | | | | between H-SMF and V-SMF. | |
| sMFHomeProvidedChargingId | string | O_{M} | 0 . . . 1 | Used when feature is active. | SMF_Charging_Id |

In an embodiment, 3GPP TS 32.255 V17.8.0 may be amended as following.

### 5.1.4 Charging Identifier

At each PDU session establishment, i.e. assignment of a new PDU session id, a new PDU session specific SMF Charging Identifier is generated at the SMF in the H-PLMN and transferred to the SMF in the V-PLMN. This Home Provided Charging Id may or shall be used by the V-SMF together with the charging ID (visited created charging ID) in the subsequence charging data request message.

For EPS handover 5GS in Home routed scenario, the Charging Identifier for the EPS PDN connection will be generated by PGW-C+SMF in HPLMN and transferred to the SMF in VPLMN, if the V-SMF has already generated the Charging Identifier, this Home Provided Charging Id may or shall be used by the V-SMF together with the charging ID (visited created charging ID) in the subsequence charging data request message.

### 5.1.9.1 General

In home routed scenario, the main parameters exchanged at PDU session establishment are:

The Home Provided Charging Id which includes the Charging Id assigned by the H-SMF and transferred by the H-SMF to the V-SMF. This Home Provided Charging Id may or shall be used by the V-SMF together with the charging ID (visited created charging ID) in the subsequence charging data request message.

In home routed scenario, the parameters exchanged during the PDU session handover from EPS to 5GS:

The Home Provided Charging Id which includes the Charging Id assigned by the H-SMF to the original PDU session over EPS and transferred by the H-SMF to the V-SMF. This Home Provided Charging Id may or shall be used by the V-SMF together with the charging ID (visited created charging ID) in the subsequence charging data request message.

### 5.2.2.12.2 PDU Session Establishment

3ch-b. A Charging Data Request [Initial] is sent to CHF, indicating “in-bound roamer”. SMF in VPLMN creates a charging ID (Visited created Charging Id) for the PDU session and sends the Charging Data Request [Initial] to CHF in VPLMN.

13. Nsmf_PDUSession_Create Response from H-SMF to V-SMF with charging Id (Home provided Charging ID).

13ch-a. Based on “received PDU session conditions” trigger, a Charging Data Request [Update] is sent to CHF with charging information received from H-SMF, which includes the HPLMN selected “Roaming Charging Profile” and counts per QFI are started and charging ID (Visited created Charging Id) and Home provided Charging ID.

Embodiments herein may provide many advantages, of which a non-exhaustive list of examples follows. In some embodiments herein, it can make the charging ID uniqueness in billing system. In some embodiments, it can simplify the charging ID generation and reporting. In some embodiments herein, it can avoid charging ID collision between SMFs. The embodiments herein are not limited to the features and advantages mentioned above. A person skilled in the art will recognize additional features and advantages upon reading the following detailed description.

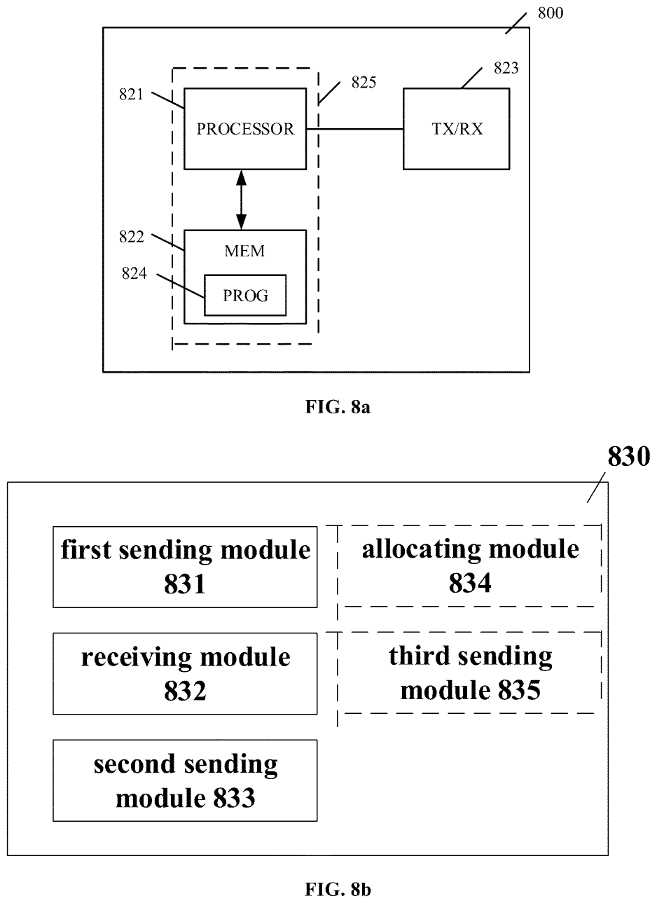

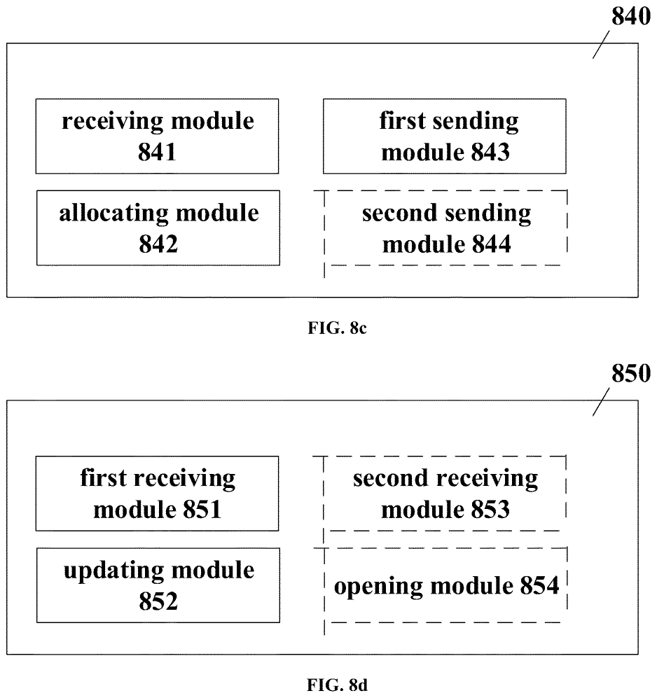

FIG. 8a is a block diagram showing an apparatus suitable for practicing some embodiments of the disclosure. For example, the first SMF or the second SMF or the first charging function described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first SMF, the memory 822 contains instructions executable by the processor 821, whereby the first SMF operates according to any of the methods related to the first SMF as described above.

In an embodiment where the apparatus is implemented as or at the second SMF, the memory 822 contains instructions executable by the processor 821, whereby the second SMF operates according to any of the methods related to the second SMF as described above.

In an embodiment where the apparatus is implemented as or at the first charging function, the memory 822 contains instructions executable by the processor 821, whereby the first charging function operates according to any of the methods related to the first charging function as described above.

FIG. 8b is a block diagram showing a first SMF according to an embodiment of the disclosure. As shown, the first SMF 830 comprises a first sending module 831 configured to send a protocol data unit (PDU) session create request to a second SMF. The first SMF 830 further comprises a receiving module 832 configured to receive a PDU session create response comprising a first charging identifier for the PDU session from a second SMF. The first SMF 830 further comprises a second sending module 833 configured to send to a first charging function a first charging data request comprising the first charging identifier and a network function instance identifier of the second SMF.

In an embodiment, the first SMF 830 further comprises an allocating module 834 configured to allocate a second charging identifier for the PDU session.

In an embodiment, the first SMF 830 further comprises a third sending module 835 configured to send an initial charging data request comprising the second charging identifier to the first charging function.

FIG. 8c is a block diagram showing a second SMF according to an embodiment of the disclosure. As shown, the second SMF 840 comprises a receiving module 841 configured to, during a protocol data unit (PDU) session establishment procedure of a home-routed PDU session, receive a PDU session create request from a first SMF. The second SMF 840 further comprises an allocating module 842 configured to allocate a first charging identifier for the PDU session. The second SMF 840 further comprises a first sending module 843 configured to send a PDU session create response comprising the first charging identifier for the PDU session to the first SMF.

In an embodiment, the second SMF 840 further comprises a second sending module 844 configured to send a charging data request comprising the first charging identifier to a second charging function.

FIG. 8d is a block diagram showing a first charging function according to an embodiment of the disclosure. As shown, the first charging function 850 comprises a first receiving module 851 configured to receive from a first session management function (SMF) a first charging data request comprising a first charging identifier for a protocol data unit (PDU) session and a network function instance identifier of a second SMF. The first charging identifier is allocated by the second SMF. The first charging function 850 comprises an updating module 852 configured to update a charging data record based on the first charging data request.

In an embodiment, the first charging function 850 further comprises a second receiving module 853 configured to receive an initial charging data request comprising a second charging identifier for the PDU session from the first SMF. The second charging identifier is allocated by the first SMF.

In an embodiment, the first charging function 850 further comprises an opening module 854 configured to open the charging data record based on the initial charging data request.

Further, the exemplary overall commutation system including the terminal device and the network node (such as the first SMF or the second SMF or the first charging function) will be introduced as below.

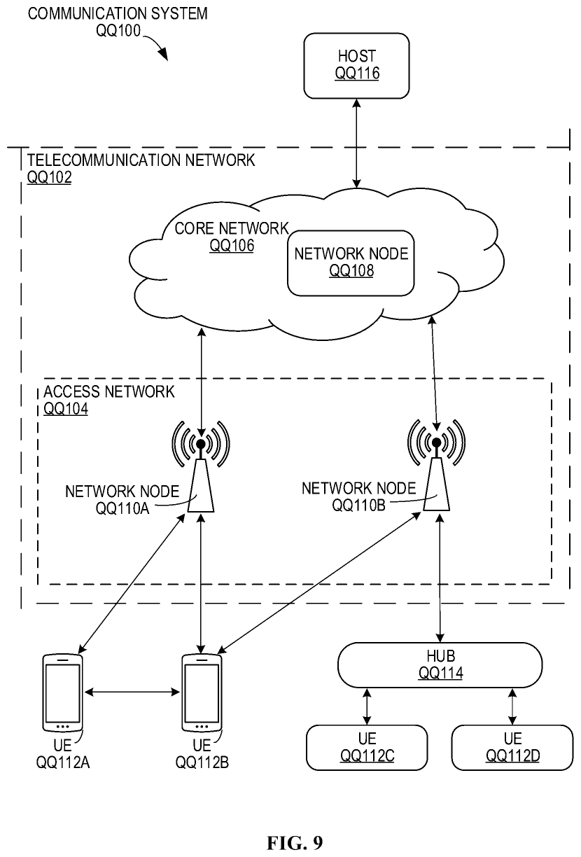

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

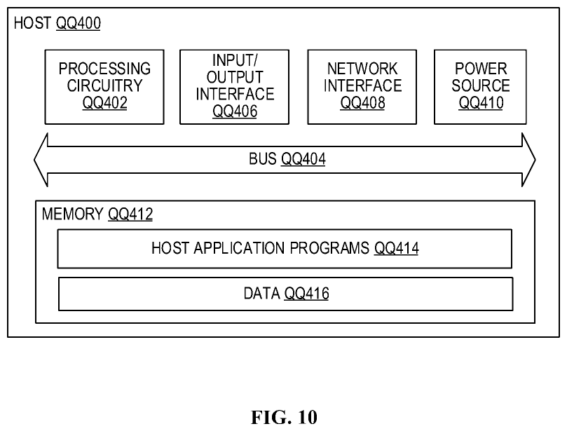

FIG. 10 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

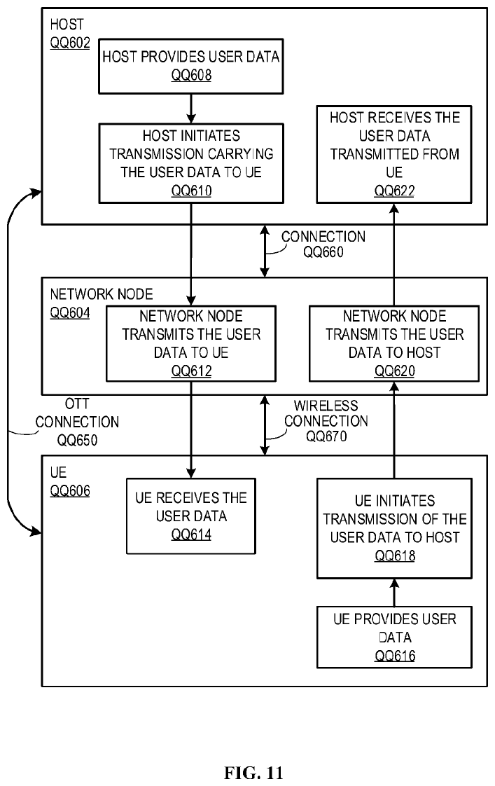

FIG. 11 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 10) discussed in the preceding paragraphs will now be described with reference to FIG. 11.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, In some embodiments herein, it can make the charging ID uniqueness in billing system. In some embodiments, it can simplify the charging ID generation and reporting. In some embodiments herein, it can avoid charging ID collision between SMFs.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first SMF or the second SMF may not need a fixed processor or memory, any computing resource and storage resource may be arranged from the first SMF or the second SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-29. (canceled)

30. A method performed by a first session management function (SMF) in a visited network, comprising:
sending to a second SMF in a home network a protocol data unit (PDU) session create request to establish a PDU session;
receiving from the second SMF in the home network a PDU session create response comprising a first charging identifier of the second SMF in the home network for the PDU session; and
sending to a first charging function in the visited network a first charging data request comprising the first charging identifier, a second charging identifier and a network function instance identifier of the second SMF.

31. The method according to claim 30, further comprising:
allocating the second charging identifier of the first SMF in the visited network for the PDU session to be established with the second SMF in the home network;
sending an initial charging data request comprising the second charging identifier to the first charging function in the visited network.

32. The method according to claim 30, wherein the first charging identifier, the second charging identifier and the network function instance identifier of the second SMF are used as an identifier of a charging data record.

33. The method according to claim 30, wherein the first charging identifier for the PDU session is received from the second SMF during at least one of:
an evolved packet system (EPS) to fifth generation system (5GS) idle mode mobility,
a handover of a home-routed PDU session, or
a PDU session establishment procedure of a home-routed PDU session.

34. The method according to claim 30, wherein the network function instance identifier of the second SMF is comprised in PDU session information.

35. The method according to claim 30, wherein the first SMF is a visited SMF, the second SMF is a home SMF and the first charging function is a visited charging function.

36. A method performed by a first charging function in a visited network, comprising:
receiving from a first session management function (SMF) in the visited network a first charging data request comprising a first charging identifier for a protocol data unit (PDU) session, a second charging identifier for the PDU session and a network function instance identifier of a second SMF, wherein the first charging identifier is allocated by the second SMF in a home network and the second charging identifier is allocated by the first SMF in the visited network; and
updating a charging data record based on the first charging data request.

37. The method according to claim 36, further comprising:
receiving an initial charging data request comprising the second charging identifier for the PDU session from the first SMF; and
opening the charging data record based on the initial charging data request.

38. The method according to claim 36, wherein the first charging identifier, the second charging identifier and the network function instance identifier of the second SMF are used as an identifier of a charging data record.

39. The method according to claim 36, wherein the network function instance identifier of the second SMF is comprised in PDU session information.

40. The method according to claim 36, wherein the first SMF is a visited SMF, the second SMF is a home SMF and the first charging function is a visited charging function.

41. A first session management function (SMF) configured for operation in a visited network, comprising:
a processor; and
a memory coupled to the processor, said memory containing instructions executable by said processor, whereby said first SMF is operative to:
send to a second SMF in a home network a protocol data unit (PDU) session create request to establish a PDU session;
receive from the second SMF in the home network a PDU session create response comprising a first charging identifier of the second SMF in the home network for the PDU session; and
send to a first charging function in the visited network a first charging data request comprising the first charging identifier, a second charging identifier and a network function instance identifier of the second SMF.

42. A first charging function configured for operation in a visited network, comprising:
a processor; and
a memory coupled to the processor, said memory containing instructions executable by said processor, whereby said first charging function is operative to:
receive from a first session management function (SMF) in the visited network a first charging data request comprising a first charging identifier for a protocol data unit (PDU) session, a second charging identifier for the PDU session and a network function instance identifier of a second SMF, wherein the first charging identifier is allocated by the second SMF in a home network and the second charging identifier is allocated by the first SMF in the visited network; and
update a charging data record based on the first charging data request.
